(19) United States
(12) Patent Application Publication
(10) Pub. No.: US 2009/0008325 A1
(43) Pub. Date: Jan. 8, 2009

(54) Affinity Foam Fractionation for Collection and Purification of Materials

(75) Inventors: Lu-Kwang Ju, Akron, OH (US); Qin Zhang, Akron, OH (US)

Correspondence Address: ROETZEL AND ANDRESS, 222 SOUTH MAIN STREET, AKRON, OH, 44308, US

(73) Assignee: THE UNIVERSITY OF AKRON, Akron, OH (US)

(21) Appl. No.: 11/912,306

(22) PCT Filed: Apr. 28, 2006
(86) PCT No.: PCT/US2006/016325

§ 371 Date: Jun. 30, 2008

Related U.S. Application Data
(60) Provisional application No. 60/676,232, filed on Apr. 29, 2005.

(51) Int. Cl. B03D 1/00; B03B 1/04; B03D 3/06; B03D 101/02; B01D 19/04; B03D 1/02

(52) U.S. Cl. 210/606; 210/704; 210/632; 210/705

(57) ABSTRACT

The present invention generally relates to methods for purifying and/or concentrating compounds from or in solutions and/or mixtures. In one embodiment, the present invention relates to a method for purifying and/or concentrating a compound from a solution or mixture. In another embodiment, the present invention relates to a method for purifying/concentrating a compound from a solution or mixture that utilizes, in whole or part, foam purification and/or concentration. In still another embodiment, the present invention can be used to separate, concentrate and/or purify any material, including biological products and/or biomaterials, that can be selectively bound to a binding agent, thereby yielding a complex that will readily partition onto bubble surfaces in a foam.

### FIELD OF THE INVENTION

The present invention generally relates to methods for purifying and/or concentrating compounds from or in solutions and/or mixtures. In one embodiment, the present invention relates to a method for purifying and/or concentrating a compound from a solution or mixture. In another embodiment, the present invention relates to a method for purifying/concentrating a compound from a solution or mixture that utilizes, in whole or part, foam purification and/or concentration. In still another embodiment, the present invention can be used to separate, concentrate and/or purify any material, including biological products and/or biomaterials, that can be selectively bound to a binding agent, thereby yielding a complex that will readily partition onto bubble surfaces in a foam.

### BACKGROUND OF THE INVENTION

During, or at the end of production, biological products are often present in dilute mixtures or solutions. Consequently, the cost of purifying them to a useful extent is often a major factor in whether a process is commercially feasible. Some collection and purification methods presently in use involve environmentally unfriendly solvents and reagents. The present invention, among other advantages, provides an environmentally friendly alternative to methods that rely in whole, or in part, on environmentally unfriendly solvents or reagents.

Foam fractionation is a promising engineering tool for protein concentration and separation because it is simple, inexpensive, environmentally friendly, and can be readily scaled-up from laboratory to pilot plant equipment. It involves, among other things, blowing gas into the production broth, thereby forming a foam. As the bubbles ascend, they concentrate surface-active agents, i.e. surfactants, on the bubble surface. Above the liquid surface, the surfactant-stabilized bubbles become foam. As the foam layer continues to rise in the fractionation column, the liquid on the foam drains due to gravity and the capillary forces at the complex foam interface, i.e. the plateau border. Such drainage leads to further concentration of the foamed surfactants. The foam may then be collected and collapsed, using a mechanical stirrer if necessary, to a liquid foamate that has a higher surfactant concentration than the original broth. In some instances, the concentration of the surfactant can increase by 40 to 100 fold.

Foam fractionation is not only more cost-effective but also has a very low environmental impact. Foam fractionation generally involves no product contamination because the main additive, and in some instances the only additive, is air or another inert gas. Other purification/concentration methods that rely in whole, or in part, upon salt precipitation are disadvantageous because salt precipitation of proteins (salting-out) may introduce contamination by traces of heavy metals present in the salt, causing possible enzyme inactivation and necessity of costly salt removal after precipitation is complete (or nearly complete). Additionally, the amount of salt required for such processes is generally tremendous, thereby causing an increase in the expense of the process due to the cost associated with the use of a large quantity of high-purity salt. As an alternative, solvent precipitation as a tool for purifying/concentrating biological products, specifically protein-based/protein-containing products, often leads to increased decay in protein activity.

A comparison with the conventional methods (solvent/salt precipitation and chromatography) is summarized below for lipase recovery.

TABLE I

| | | | Foam |
|---|---|---|---|
| Criteria | Precipitation | Chromatography | Fractionation |
| Purification Factor-a | 2.4 | 4 | 1.5 |
| Enrichment Factor-b | 10 | 40 | 80 |
| Process Time | 12 hours | — | Minutes |
| Operation Expenditure | Low | High | Low |
| Investment Costs | Moderate | High | Low |
| Running Costs | High | Moderate | Low |
| Environmental | High | Moderate-High | Low |
| Pollution | | | |

a (U/mg protein)/(U/mg protein)0
b (U/mL)/(U/mL)0
where U stands for the unity of enzyme activity and the subscript “0” refers to the activity before the recovery operations.

Previous investigations into foam fractionation yielded the belief that cellulase was principally responsible for foaming because an increase in foaming appeared to be roughly parallel to the profile of cellulase production. However, further investigation by the inventors has demonstrated that this is not correct. Specifically, while separating cellulase from a fermentation broth using foam fractionation it was discovered that cellulase is surface-active but not the most surface-active component of the broth. Therefore, we could not selectively foam out the cellulase component. None of the individual cellulase components (i.e. endo-glucanases, exo-glucanases and β-glucosidases) showed appreciably higher activities in the collected foamate than in the original broth.

Despite the promising potential, foam fractionation has been largely undeveloped because of a lack of understanding of the process. Furthermore, the inventors have discovered that the product of interest often does not have the highest partition activity among all of the materials present in the product-bearing broth. In view of this, the simple foam fractionation processes/methods mentioned in the literature cannot yield an acceptable outcome. Accordingly, there is a need in the art for a foam fractionation method that yields increased purification/concentration results, even when the product of interest does not have the highest partition activity among all of the materials present in the product-bearing broth.

### SUMMARY OF THE INVENTION

The present invention generally relates to methods for purifying and/or concentrating compounds from or in solutions and/or mixtures. In another embodiment, the present invention relates to a method to purify and/or concentrate a compound from a solution, or in a mixture. In another embodiment, the present invention relates to a method for purifying/concentrating a compound from a solution, or in a mixture, that utilizes, in whole or part, foam purification and/or concentration. In still another embodiment, the present invention can be used to separate, concentrate and/or purify any material, including biological products and/or biomaterials, that can be selectively bound to a binding agent, thereby yielding a complex that will readily partition onto bubble surfaces in a foam.

The present invention generally relates to a process for purifying biological products using foam fractionation. More specifically, the present invention relates to affinity foam fractionation, wherein the ability of the process to separate a biological product from a mixture is enhanced by modifying the biological product in a manner that provides the biological product with an enhanced affinity for a foam. The process applies to a wide variety of biological products, the only requirement being that the biological product of interest must be capable of being derivatized in a manner that enhances its affinity for a foam.

In still another embodiment, the present invention can be used to separate, concentrate and/or purify any material, including biological products/biomaterials, that can be selectively bound to a binding agent, thereby yielding a complex that will readily partition onto bubble surfaces in a foam.

The present invention also relates to a process for separating, concentrating and/or purifying a material from a solution or mixture using a foam, comprising the steps of modifying a composition to be separated, concentrated and/or purified to enhance the material's affinity for a foam; forming a foam from a solution containing the modified composition; and separating, concentrating and/or purifying the composition from the foam.

The present invention also relates to a process for foam fractionating chemical compounds comprising providing a vessel for containing a liquid comprising one or more chemical compounds to be fractionated, wherein the vessel includes a means for foaming the liquid contained therein; providing the liquid disposed in the vessel and containing one or more chemical compounds to be fractionated, wherein the one or more chemical compounds are modified with an affinity-foaming agent so that they tend to preferentially segregate onto a foam rather than the liquid; activating the means for foaming, thereby forming the foam from the liquid; and collecting the foam.

The present invention still further relates to a product purified by the foregoing process.

### BRIEF DESCRIPTION OF THE FIGURES

FIG. 1 is a flowchart showing a process of breaking down cellulose into glucose by hydrolysis;

FIG. 2 is plot of Enrichment Ratios (ER) of cellulase activity (FPU) at different percentages of cellulose hydrolysate (CH) for three cell-free systems; System I—hydrolysate-based broth+non-autoclaved CH, System II—hydrolysate-based broth+autoclaved CH, System III—glucose plus cellulose-based broth+autoclaved CH;

FIG. 3 is a plot of values of E/P at different percentages of cellulose hydrolysate for three cell-free systems (as described in FIG. 1);

FIG. 4 is a plot of Enrichment ratios (ER) of FPU and individual cellulase components, i.e., endoglucanases, exoglucanases, and β-glucosidases, at different percentages of cellulose hydrolysate for System II;

FIG. 5 is a plot comparing the effects of carboxymethylcellulose (CMC) and cellulose hydrolysate (CH) addition on foam fractionation, in terms of enrichment ratios (ER) of FPU, extracellular proteins and reducing sugars. Control had no addition of CMC or CH;

FIG. 6 is a plot comparing different types of CMC for enrichment ratios of FPU. DS refers to Degree of Substitution (at 70%, 90%, and 120%), and MW refers to Molecular Weight (L—low, M—medium, and H—high);

FIG. 7 is a pair of plots comparing the effects of (a) xylan hydrolysate (XH) addition and (b) cellulose hydrolysate (CH) addition on foam fractionation of FPU and individual cellulase components, i.e., endoglucanases, exoglucanases and β-glucosidases, from cell-free, lactose-based broth supernatant;

FIG. 8 is a set of graphs showing the effect on cellulase enrichment ratios when PMMA-co-MAA is added to a broth; and

FIG. 9 is a set of graphs showing the effect on cellulase enrichment ratios when PMMA-co-MAA-cellobiose is added to a broth.

### DETAILED DESCRIPTION OF THE INVENTION

The present invention generally relates to methods for purifying and/or concentrating compounds from or in solutions and/or mixtures. In another embodiment, the present invention relates to a method to purify and/or concentrate a compound from a solution, or in a mixture. In another embodiment, the present invention relates to a method for purifying/concentrating a compound from a solution, or in a mixture, that utilizes, in whole or part, foam purification and/or concentration. In still another embodiment, the present invention can be used to separate, concentrate and/or purify any material, including biological products and/or biomaterials, that can be selectively bound to a binding agent, thereby yielding a complex that will readily partition onto bubble surfaces in a foam.

The following terms are specially defined herein. Filter paper unit (FPU) includes the amount of enzyme causing 2.0 mg of reducing sugar equivalents to be released in 1 h at 50° C. and a pH of 4.8. Enrichment ratio (ER) includes the ratio of enzyme activity (FPU) in the foamate divided by that of the remaining liquid from which the foam was made, i.e. the residue. When the ER is calculated in this manner it is referred to herein as an FPU ER. Alternatively, the enrichment ratio can be calculated as the extracelular protein concentration of the foamate divided by that of the residue. When the ER is calculated in this manner it is referred to as the Extra-P ER. As used herein, the term affinity-foaming agent includes any compound that binds with a target compound, which is intended to be purified and increases that target compound's tendency to segregate onto bubble surfaces when a solution of the target compound is subjected to foam fractionation. Some representative affinity-foaming agents include, without limitation, sophorolipids, rhamnolipids, PMMA-co-PMAA-cellobiose, or any combination thereof.

The present invention generally relates to a process for purifying biological products using foam fractionation. More specifically, the present invention relates to affinity foam fractionation, wherein the ability of the process to separate a biological product from a mixture is enhanced by modifying the biological product in a manner that provides the biological product with an enhanced affinity for a foam. The process is applicable to a wide variety of biological products, the only requirement being that the biological product of interest must be capable of being derivatized in a manner that enhances its affinity for a foam. In some embodiments, the present invention can be used to separate, concentrate and/or purify materials, including biological products/biomaterials, that can be selectively bound to a binding agent, thereby yielding a complex that will readily partition onto bubble surfaces in a foam.

As noted above, many biological products are surface-active but not very active in a fermentation broth. Accordingly, these biological products cannot be selectively foamed out using established non-affinity foam fractionation methods. To enhance the selectivity of foam fractionation, a new technology/process/methodology has been developed. The process of the present invention will hereinafter be known as affinity foam fractionation (AFF).

In one embodiment, the process/method of the present invention involves the use of cellulose hydrolysates, and analogs such as carboxymethylcelluloses (CMCs). The hydrosylates can have a variety of molecular weights (MW) and degrees of substitution (DS). They are added to a mixture containing the target compound to selectively bind thereto and form hydrophobic complexes that readily partition onto the bubble surfaces. In another embodiment cellobiose and/or related compounds are used to derivatize the target compound. In still other embodiments cellobiose is linked to a hydrophobic polymer that enhances its foam affinity.

The effects of cellulase concentration (concentration is denoted in terms of the Filter Paper Unit or FPU), hydrolysate/analog-to-FPU ratio, type of hydrolysate/analog, and presence of cells are evaluated in order to determine the ability of the above-mentioned process/method to increase the efficiency of foam fractionation. The foaming properties measured include foaming speed, foam stability and dryness, foamate volume and FPU, and enrichments of FPU and individual cellulase components. In some cases the foamate FPU could be as high as 5 fold of that in the broth. Among cellulase components, exoglucanase is enriched the most (3 fold), endoglucanase the next (2.3 fold), and β-glucosidase the least (1.4 fold). Generally, with CMC, those having low DS and high MW performed better.

### Selective Binding of the Desired Biological Product

Selective binding of the one or more desired biological products can involve various interactions between the desired biological product(s) and a ligand, such as hydrogen-bonding, ionic-bonding, and hydrophobic interactions. The most common examples can generally be categorized into six types of interactions:
(1) Enzyme-substrate interactions—Enzymes are protein-based catalysts that have high affinity to specific substrates. Substrate analogs and competitive inhibitors can also engage in affinity binding with the enzymes.
(2) Antibody-antigen interactions—Antibodies are immunoglobulin proteins produced by the immune system of vertebrates. Examples include, but are not limited to, IgM, IgG, IgD, IgA, and IgE. These proteins have hyper-variable domains known as complementary-determining regions that recognize and bind with the specific regions (epitopes) on the foreign substances (antigens).
(3) DNA-protein interactions—Proteins known as transcription factors regulate gene expression, generally by binding to a control region of the gene. These regions usually form the major groove of the DNA double helix. These DNA domains (motifs) used for binding proteins include, but are not limited to, helix-turn-helix, leucine zipper, β-ribbons, TATA box, and zinc finger protein domains.
(4) Cell receptor-ligand interactions—Cells communicate either through direct contact or via the secretion of chemical substances that are recognized by a receptor in the target cell. In the latter case, the receptors can appear on the surface of the cell or inside the cell. Extracellular receptors include ion-channel receptors, G-protein-linked receptors, and enzyme-linked receptors.
(5) Biotin-avidin/streptavidin interactions—Biotin-labeled biomolecules can be isolated, almost irreversibly, using immobilized avidin or streptavidin.
(6) Lectin-carbohydrate interactions—A lectin is a type of protein that contains at least two binding sites for specific carbohydrates. The lectins that bind monosaccharides are not only specific for a sugar, but also specific to a particular isomer. Certain lectins demonstrate a higher affinity for oligosaccharides than monosaccharides.

Clearly, the above list is not exhaustive, and other selective binding mechanisms exist for many major groups of biological products (or biomaterials—e.g., proteins/enzymes, poly- or oligo-nucleotides, carbohydrates, and even cells). Given this fact, any mechanism that permits the selective binding of a desired biological product can be incorporated into the present invention's affinity foam fractionation technology for selective separation and purification of the desired biological product (biomaterial). This includes, but is not limited to, currently the most important industrial and medical biological products/biomaterials: numerous proteins, enzymes, monoclonal antibodies, and poly- or oligo-nucleotides.

### Affinity Foam Fractionation

Some of the following examples relate to the cellulase separation from the fermentation broth of the fungus Trichoderma reesei. However, it should be noted that the present invention is not limited thereto. Instead, the present invention can be used to separate, concentrate and/or purify any material, including biological products/biomaterials, that can be selectively bound to a binding agent, thereby yielding a complex that will readily partition onto bubble surfaces in a foam. Other cells that can be used for cellulase production include, without limitation, Clostridium thermocellum, Ruminococcus albus, Streptomyces, Thermoactinomyces, Thermomonospora curvata, Acremonium cellulolyticus, Aspergillus acculeatus, Aspergillus fumigatus, Aspergillus niger, Fusarium solani, Irpex lacteus, Penicillium funmiculosum, Phanerochaete chrysosporium, Schizophyllum commune, Sclerotium rolfsii, Sporotrichum cellulophilum, Talaromyces emersonii, Thielavia terrestris, Trichoderma koningii, Trichoderma reesei, Trichoderma vidde, or any combination thereof.

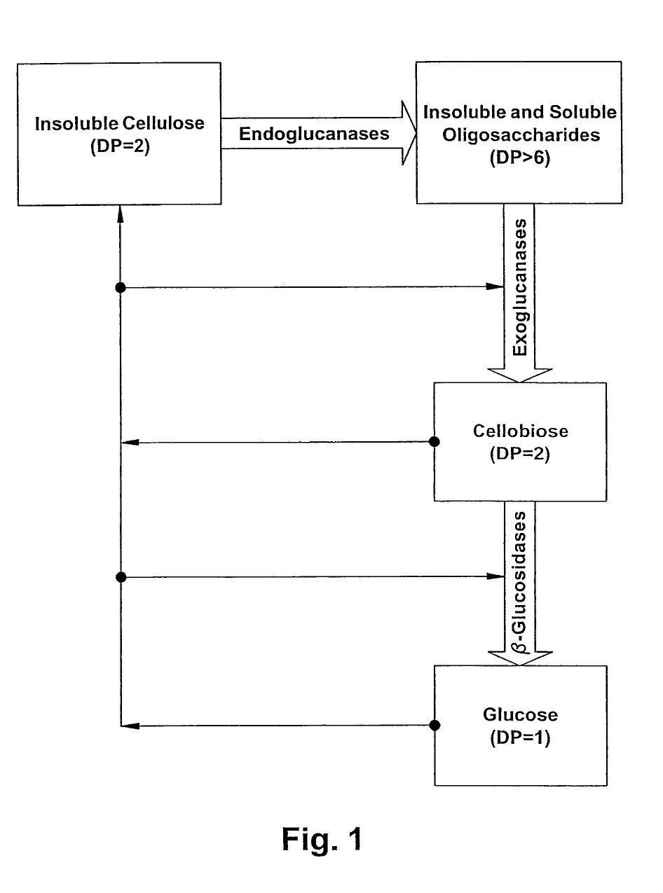

Regarding the following examples and the cellulase separation from a fermentation broth of the fungus Trichoderma reesei (T. reesei), this process is subject to complex metabolic regulation: both induction and glucose repression. Cellulase is a group of enzymes that, by concerted action, hydrolyze cellulose to glucose. Three distinct enzymatic activities are required: 1) a β-1,4-glucan glycoanohydrolyase that has endocellulase activity, 2) a β-1,4-glucan cellobiohydrolyase that has exocellulase activity, and 3) a β-glucosidase that cleaves cellobiose to glucose. The aspects of this enzyme's activity that are relevant to the present case comprise the following. Hydrolysis begins with a random internal attack by the endoglucanase disrupting the crosslinking and creating new polymer ends, which accessible to exocellulase. Hydrolysis also solubilizes the substrate by reducing intrachain hydrogen bonding. The cellobiohydrolase attacks the non-reducing end of cellulose and generates cellobiose with some larger oligosaccharides. Finally, the β-glucosidate completes the breakdown process by generating glucose from cellobiose. FIG. 1 sets forth the above process in flow chart form. The thick arrows with text indicate the point where an enzyme generally enters the process. The thin lines show the feedback effect where the products of one enzyme are the substrates of another. As shown, the degradation process ends with the production of glucose.

In some embodiments derivatization can occur as follows. An enzyme binds to a substrate, which has an affinity for a foam. The enzyme remains bound to the substrate long enough to be subjected to foam fractionation, and collected.

As described earlier, these enzymes have selective binding affinity to their substrates, substrate analogs, or compounds containing domains/moieties of the substrates or analogs. The affinity binding of these agents with the active site of a protein also serves to protect the enzymes from being denatured during the foaming process. Protein denaturation at gas-water interfaces by foaming may/can occur due to hydrodynamic shear arising from the interfacial forces and/or the significant difference in hydrophobicity between the aqueous broth and the bubble/foam surface.

In some of the examples shown below, the effects of substrate additives on affinity foam fractionation are set forth. The substrates can include hardwood hydrolysates, carboxymethyl cellulose (CMC), and/or xylan hydrosylates. As known to those of ordinary skill in the art, cellulase hydrolyzes both CMC and xylan, indicating the existence of a certain binding affinity of cellulase to these materials. Thus, CMC and xylan are included in some of the following examples. The following examples are merely illustrative and in no way limit the present invention. The claims alone will serve to define the scope of the present invention.

### Materials and Methods:

a) Fermentation:

T. reesei Rut C-30 (NRRL 11460) is obtained from United States Department of Agriculture (Agricultural Research Service Patent Culture Collection, Peoria, Ill.). The microorganism is maintained at 4° C. on slants of Potato Dextrose Agar (Sigma; 39 g/L, as recommended), with regular sub-culturing every 3 to 4 weeks.

To prepare inoculum for each fermentation experiment, three loops of cells are transferred from an agar slant to a 250-mL pre-culture flask containing 50 mL of Potato Dextrose medium (Sigma). After two days of cultivation at room temperature and 250 rpm, the broth is added to a 2-L flask containing 500 mL of a defined medium modified from that used by Mandels and Weber. For cellulase production, the defined medium requires not only C-substrates as the source of material and energy for cell growth and maintenance but also inducers to activate the expression of all cellulase components. In this study, three medium systems are compared for their cellulase synthesis capacity and, more importantly, for their foaming properties. The first medium includes 5 g/L of glucose as the C-substrate and 5 g/L of pure cellulose as the inducer and C-source (upon hydrolysis by cellulase produced by cells). The second medium contains a hardwood hydrolysate (with 12 g/L of reducing sugars, preparation adapted from the paper by Lee, Patrick; and Moore, Millicent: Abstracts of Papers (2002), 223rd ACS National Meeting, Orlando, Fla., USA) as both the C-substrate and the inducer.

The above two media are used in batch fermentation process to generate the broths used in the foaming study. The broths for the current foaming studies are generally harvested on the fifth day when the cellulase activity (assayed in FPU, i.e., Filter Paper Unit) reached the highest level.

The third medium is lactose-based, i.e., with lactose serving as both the carbon substrate and the inducer. The fermentation with this medium is conducted in a batch-then-continuous mode. The original medium has 10 g/L of lactose; the feed for continuous culture has 20 g/L of lactose. The culture is grown to the late exponential-growth phase and then converted to a continuous culture, with the feed rate computer-controlled according to a pH-based algorithm (details described in Lo, Chi-Ming; Zhang, Qin; and Lu-Kwang, Ju: Submitted to the 27th Symposium on Biotechnology for Fuels and Chemicals (2005)). The broth used in the foaming study is collected after about one week into the continuous culture.

To avoid foaming, which would otherwise necessitate the addition of one or more anti-foaming agents, surface aeration at the rate of 1 VVM (volume of gas per volume of liquid per minute) is employed for an oxygen supply into the broth that is magnetically stirred at the rate of about 250 rpm. The fermentation is kept at about room temperature (herein defined as about 24° C.±1° C.). Samples are taken daily. Cell-free media are used in most of the foaming experiments conducted. In this case, the harvested fermentation broth is centrifuged at about 8,000 rpm for about 10 min (9,300 g, Sorvall RC 5C Plus Super-speed Centrifuge, Sorvall, Newtown, Conn.) to remove the biomass. The supernatant is collected for the subsequent affinity foaming study.

b) Affinity Foaming Study:

An affinity foaming study is conducted in a 250-mL graduated cylinder. The volume of liquid sample used is 40 mL. An air diffuser (air stone), placed at the bottom of the cylinder, is used to generate fine bubbles for the foaming study. The total volume before foaming, including both the liquid sample and the air stone, is 50 mL. The air bubbling rate is kept at 1 VVM (i.e., 40 mL/min) using a flow meter with a three-way valve. Upon bubbling, the foam reached the top of the highest level within 5 min. The total foamed volume is recorded. The bubbling is then stopped to allow the foam to collapse. The collapsing rate is also recorded as an indicator of the foam stability. The air bubbling is resumed again. While maintaining the foam at the highest level, the liquid broth remaining at the bottom (residue) is collected and its volume (Vᵣ) is measured by a 50-mL volumetric cylinder. The foam in the foaming cylinder is the collapsed (if necessary, by blowing an air stream on the foam surface), and the cylinder wall and the air stone are rinsed with a known volume of de-ionized water (V_{w}). The diluted foamate is collected for analysis. The “actual” foamate volume (V_{f}) is obtained by subtracting Vᵣ from the initial sample volume (40 mL). The dilution factor, (1+V_{w}/V_{f}), is used to adjust all the analysis concentrations obtained with the diluted foamate.

c) Analytical Methods:

i) Reducing Sugar, Solids, and Cellulose Concentrations:

The reducing sugar concentration is measured by the non-specific dinitrosalicylic acid (DNS) method, based on the color formation of DNS reagent when heated in the presence of reducing sugars (see Miller, W. M.; Blanch, H. W.; and Wilke, C. R.: Biotech. and Bioeng., Vol. 32, pp. 947-965 (1988), for further details). The DNS reagent is prepared by dissolving 10 g of 3,5-dinitrosalicylic acid in 400-ml distilled water, adding 200 ml of 2 M NaOH, and then diluting the solution to a total volume of 1 L with distilled water.

For the solids dry-weight concentration, a 10-ml sample is taken from the fermentation and is centrifuged at 8,000 rpm. The solids collected are washed with distilled water twice, transferred to an aluminum weighing pan, and dried in an oven at 100° C. for 24 h. The solids concentration is calculated accordingly. Cellulose concentration is difficult to measure directly. Instead, as the solids comprised cells and cellulose, the cellulose concentration is obtained herein by subtracting the cell dry-weight concentration from the solids concentration. As described below, the cell dry-weight concentration is converted from intracellular protein concentration, using the calibration curve established with broth samples taken from cellulose-free fermentation, with glucose as the sole carbon source.

ii) Cell Concentration:

Because of the presence of cellulose, cell dry-weight concentration could not be measured directly. Intracellular protein concentration is measured instead, as described below: By centrifugation, the solids in broth samples are collected and washed twice with distilled water. The cells are then lysed in 3 mL of 0.2 N NaOH, at 100° C. for 20 min. The protein concentration of the lysate is then measured by the standard Lowry method. The absorbance at 595 nm is measured with a UV/VIS spectrophotometer (Perkin-Elmer Lambda 3B).

To establish the relationship between the intracellular protein concentration and cell dry-weight concentration, batch fermentation is made with glucose as the sole carbon source. Samples taken at different stages of the fermentation are analyzed for both cell dry-weight concentration and intracellular protein concentration. The relationship is established as:

Cell Dry-Weight Concentration (g/L)=Intracellular Protein Concentration (g/L)×8.0(±0.5)

iii) Cellulase Activity:

The total activity of cellulase is measured by the standard filter paper assay method (see Mandels, M.; Andreotti, R.; and Roche, C.: Biotechnol. Bioeng. Symp. 6, pp. 21-33 (1976) for further details). Assays for the activity of individual enzyme components, i.e., endoglucanase, exoglucanase, and β-glucosidase are briefly described below:

Endoglucanase: A modified method of Berghem and Petterson (see Gunjikar, T. P.; Sawant, S. B.; and Joshi, J. B.: BiotechnoL Prog., Vol. 17, pp. 1166-1168 (2001), and Berghem, L. E. R. and Petterson, L. G.: Eur.J.Bichem., Vol. 37, pp. 21-30 (1973), for further details) is used. A 1% carboxymethylcellulose (CMC) solution is prepared in 0.05 M sodium acetate buffer (pH 5). The CMC solution is incubated with 0.28 mL of the test enzyme solution at 50° C. for 30 min. Three (3) mL of 1% DNS reagent is added to terminate the reaction. The reducing sugar concentration produced from the enzymatic reaction is then measured and used to calculate the endoglucanase activity according to the following equation:

Endoglucanase Activity (U/mL)=Reducing Sugars Released (mg)×0.66

Exoglucanase: A modified method of Berghem and Petterson is used. One (1) mL of the test enzyme solution is added to 1 mL of 2% Avicel suspension prepared in 0.05 M sodium acetate buffer (pH 5). After 30-min incubation at 40° C., 3 mL of 1% DNS reagent is added to end the reaction and the resultant reducing sugar concentration is measured. The exoglucanase activity is calculated according to the following equation:

Exoglucanase Activity (U/mL)=Reducing Sugars Released (mg)×0.18

β-Glucosidase (Cellobiose): Three test tubes are used. The test tube for cellobiose blank contained 1.0 mL each of 15 mM cellobiose solution, citrate buffer (pH 4.8), and water. A second test tube, for the sample blank, contained 1.0 mL sample and 2.0 mL water. The third tube, for the test sample, contained 1.0 mL each of the cellobiose solution, buffer, and the test sample. The test tubes are mixed, capped tightly, and incubated at 50° C. for 30 min. Again, 3 mL of the DNS reagent are added and the resultant reducing sugar (glucose) concentration is measured by the DNS method. The absorbance of the sample, subtracted by those of the sample blank and the cellobiose blank, is used in determining the reducing sugar concentration. The β-glucosidase activity is determined according to the following equation:

β-Glucosidase Activity (U/mL)=Glucose Released (mg)×0.0926

Please note, the following examples contains six parts according to the different foaming agents added, i.e., cellulose (hardwood) hydrolysate (CH), carboxymethyl cellulose (CMC), xylan hydrolysate (XH), PMMA-co-MAA-cellobiose, sophorolipids, and rhamnolipids.

### EXAMPLE 1

### Affinity Foam Fractionation with Addition of Cellulose Hydrolysate

The results from an experiment displaying the typical effects of three factors on the foaming behaviors are summarized in Tables 1 and 2 attached hereto. The factors are: (1) the presence or absence of cells in the foaming broth; (2) the different growth stages of the cells present; and (3) the hydrolysate addition. The cells used in cell-containing systems are pre-grown in a glucose-based medium (with 10 g/L glucose). For studying the effects of different growth stages, the cells are harvested either at the late exponential growth phase (the third day of batch cultivation) or at the stationary phase (the fifth day). The broth supernatant used as the basal cellulase-bearing medium in all of the systems is prepared by a fermentation using the hydrolysate-based medium. The broth is harvested on the fifth day, and centrifuged to remove the cells. The use of the same basal broth supernatant helped to ensure that different systems in the study differed only in the added cells and/or CH. The cell-containing systems are added with the same cell concentration, approximately 3 g/L. The CH-containing systems are added with 5% CH shortly before the foaming study. The hydrolysate added is prepared to have the same medium composition (C-source omitted) so that the hydrolysate addition has minimal effects on other broth properties.

The observations on foaming speed and foam stability are summarized in Table 1. The hydrolysate-based broth foamed readily and the foam is quite stable, significantly more so than the lactose-based broth, as described in more detail below. The presence of cells slowed down the foaming speed and made the foam less stable. The addition of CH also slowed down the foaming speed in the cell-free systems but has minimal effect in the cell-containing systems.

The enrichment ratios (ER) for cells, reducing sugars, cellulase (FPU) activity, and extracellular proteins achieved are reported in Table 2. The ER for cells is defined as the ratio of cell concentration in the foamate to that in the original broth. ER for other parameters is similarly defined. The results in Table 2 indicated the following:
(1) CH addition enriches cellulase in all systems. The ER is larger in the cell-free systems.
(2) CH addition significantly decreases the partition of extracellular proteins that have no cellulase activity, resulting in much lower ER of proteins. Together with the increased enrichment of cellulase, the observation indicates a clear selectivity of CH toward cellulase. The complex formed between cellulase and the pertinent CH components (presumably the cellulose oligomers) out-compete the other proteins in partitioning onto the bubble/foam surface; consequently, causing the decrease in ER of proteins.
(3) CH addition seems to decrease the removal of reducing sugars, although the effect is significant only in the cell-free systems. ER of reducing sugars is smaller than 1 in all of the systems.
(4) The presence of cells does not affect ER of FPU, proteins and reducing sugars substantially, but the cells are removed by foaming. CH addition increases the extent of cell removal. Cells harvested at the two different growth stages behave similar in the broth foaming.

The above observations are qualitatively reproducible in all of the subsequent foaming experiments conducted with the hardwood hydrolysate as the affinity foaming agent. Note that the hydrolysate have approximately 12 g/L of reducing sugars. Thus, the 5% addition used in the above experiment corresponded to addition of approximately 0.6 g/L of reducing sugars. The predominant majority of the reducing sugars in the hydrolysate are glucose (40%) and xylose (27%). Assuming that only the oligomers had the high affinity in binding cellulase and forming more hydrophobic complex for enhanced partition onto foam surface, the amount of “actual” foaming agents introduced is very low. Upon developing methods to produce CH with larger fractions of oligomers, the efficiency of affinity foam fractionation of cellulase may be greatly improved.

Further experiments are conducted in cell-free systems to evaluate the effects of increasing CH fractions, up to 75%, on the foam fractionation. These experiments are done with three combinations of the broth supernatant (from hydrolysate-based or glucose plus Avicel cellulose-based fermentation) and the type of CH as a foaming agent (with or without autoclaving at 121° C. for 15 min):
System 1—non-autoclaved CH added to hydrolysate-based broth supernatant;
System 2—autoclaved CH added to hydrolysate-based broth supernatant; and
System 3—autoclaved CH added to glucose plus cellulose-based broth supernatant.

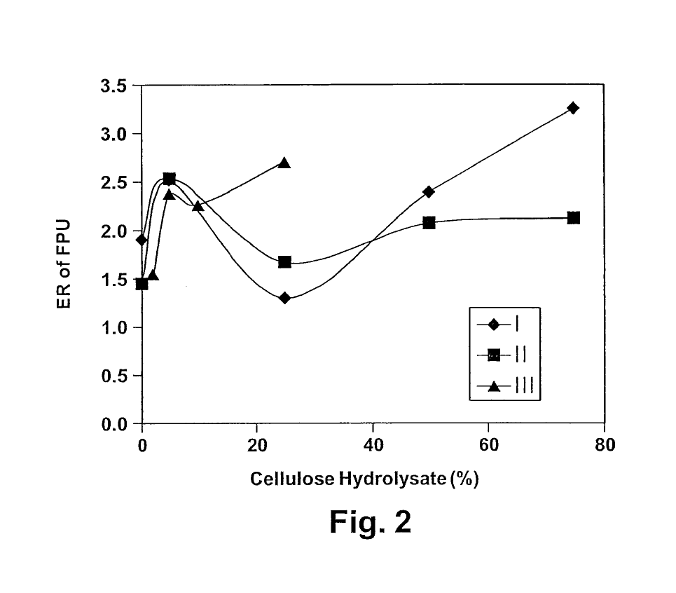

The ER of FPU achieved in these three systems, at different CH fractions, are summarized in FIG. 2 (see I to III, which correspond respectively to Systems 1 to 3). CH addition is found beneficial in all of the three combinations, giving maximal ER of 2.6-3.4. The cause for the dips at 25% CH in Systems 1 and 2 are unknown, but the trend is reproducible in both systems. Autoclaved and non-autoclaved CH behaved similar except at a very high fraction (75%).

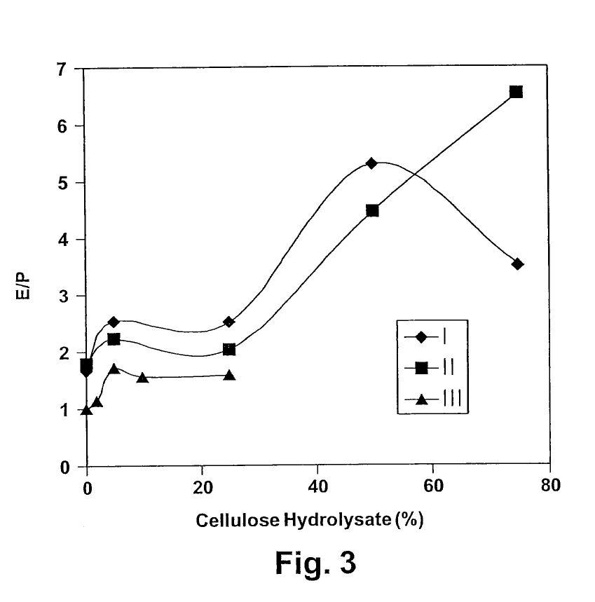

Affinity foam fractionation by CH addition improved the purity, in addition to concentration/enrichment, of the cellulase in foamate. This is shown in FIG. 3, by the substantially higher values of E/P in foamate (Enzyme-to-Proteins, calculated by dividing FPU by the concentration of extracellular proteins) with increasing CH fractions for the three systems.

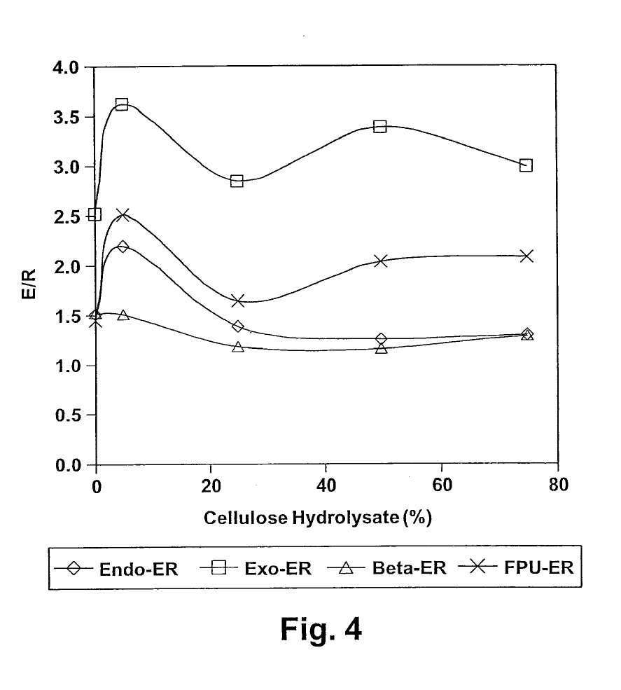

As described above, cellulase includes three groups of components: endoglucanases, exoglucanases, and β-glucosidases. It is important to evaluate the effect of CH addition on foam fractionation of individual groups of cellulase. The ER for cellulase components at different CH fractions are shown in FIG. 4 for System 2. (The profiles are essentially the same for System 1, but have not been measured for System 3.) Exoglucanases are the primary component enriched. Enrichment of the other two components, particularly endoglucanases, is also observed at a low CH fraction of 5%. The enrichment diminished at higher CH fractions, and for β-glucosidases, it even dropped below the level attained without CH addition. Although not wishing to be bound solely to the following theory, the poor enrichment in endoglucanases and/or β-glucosidases can be viewed as responsible for the lower ER (2.0-2.5) of overall FPU than those (3.0-3.6) of exoglucanases.

Again, while not wishing to be bound solely to the following theory, the different effects on cellulase components are probably associated with the different sizes of oligomers preferred by the different components as substrates. With the primary function of hydrolyzing cellobiose (dimer), β-glucosidases are expected to have higher affinity to smaller oligomers, which are very water soluble and tend not to partition onto the foam surface. To enhance the enrichment of β-glucosidases would require attaching the small oligomers to another hydrophobic entity so that the bound complexes would partition actively to the foam surface. On the other hand, endoglucanases function to cleave long cellulose chains. Presumably, they would have higher affinity to larger oligomers (more so than the exoglucanases, which can bind to shorter chains for their function of cleaving the chains at the end). The poor enrichment of endoglucanases observed might be a result of the extremely low concentration of large oligomers present in CH, which is prepared to contain primarily glucose. Methods designed to obtain longer oligomers in the hydrolysate are desirable for optimizing the efficiency of the affinity foaming technology, and are within the scope of the present invention.

### EXAMPLE 2

### Affinity Foam Fractionation with Addition of CMC

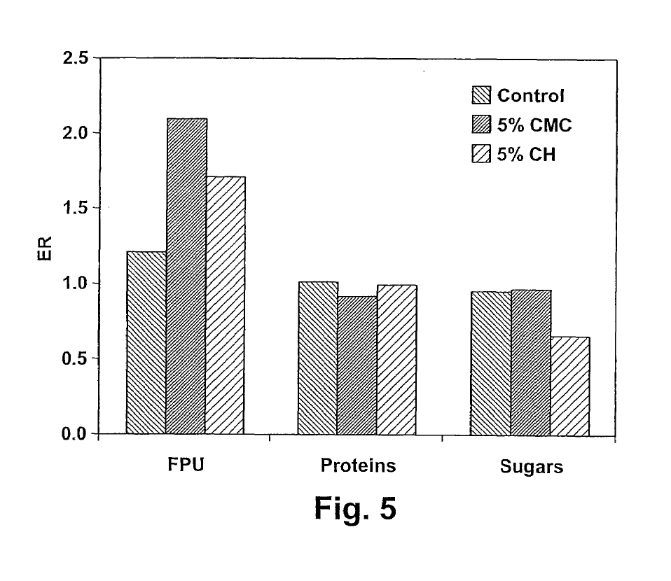

CMCs are modified, water-soluble, long-chain cellulose analogs. The potential use of CMCs for affinity foam fractionation of cellulase is discussed below. An experiment is carried out in cell-free supernatant of the broth collected from a hydrolysate-based fermentation. To obtain higher FPU (approximately 0.7) than that from the earlier batch cultivation (approximately 0.3-0.4 FPU), the fermentation is supplemented with a lactose-based continuous feed after reaching the stationary phase. Three systems are compared: (a) the broth supernatant (control); (b) the supernatant added with 5% (v/v) of a 5-g/L CMC solution; and (c) the supernatant added with 5% of a hardwood CH (having 16 g/L of reducing sugars). The ER of FPU, extracellular proteins, and reducing sugars are shown in FIG. 5. The CMC solution is found to perform as well as, if not better than, CH in cellulase enrichment.

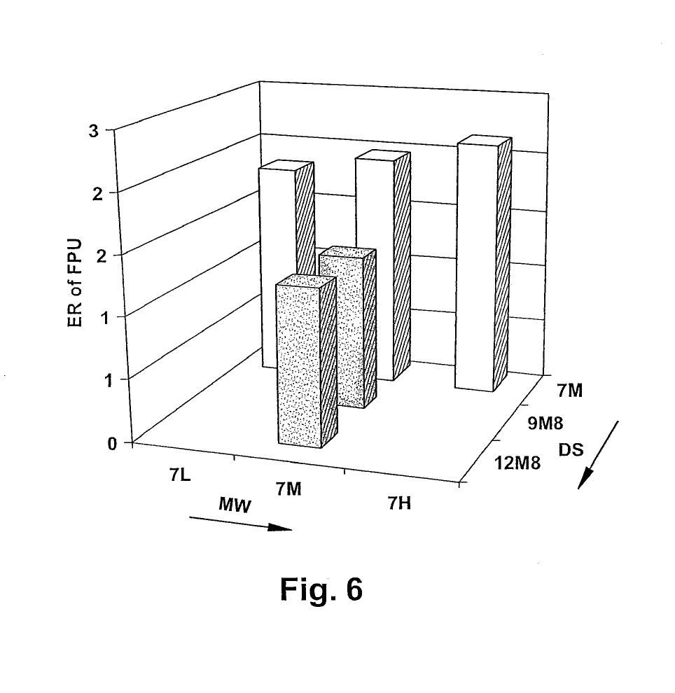

CMC is available commercially in several molecular weights (MW) and degrees of substitution (DS, in introduction of the carboxylic acid group). The CMC used in the above experiment belonged to the type “7L”: “7” stands for a 70% DS (i.e., on average, 70% of the glucose units have an acid group attached), and “L” stands for low MW (approximately 90,000). To study the effects of DS and MW on the affinity foaming performance, an experiment is conducted with 5 systems, each added with 5% (v/v) of a specific type of CMC (10-g/L solution)—7L, 7M, 7H, 9M8, and 12M8, where M and H refer to medium and high MW (approximately 250,000 and 700,000, respectively), and 9M8 and 12M8 refer to approximately 90% and 120% DS (and the “8” indicates that the viscosity of a 2% solution is approximately 800 centipoises), respectively. The ER of FPU obtained is shown in FIG. 6. CMC with the lower DS (at 70%) performed significantly better than those of higher DS, presumably because the higher DS decreased the affinity between cellulase and the modified sugar chains. Increasing MW also has a positive effect on the cellulase enrichment.

### EXAMPLE 3

### Affinity Foam Fractionation with Addition of Xylan Hydrolysate

The results of an experiment comparing the effects of xylan hydrolysate (XH) and cellulose (hardwood) hydrolysate (CH) in affinity foam fractionation of cellulase are given in Table 3. The cell-free broth supernatant is collected from the lactose-based fermentation, as described in Materials and Methods. The lactose-based broth, despite its much higher FPU (approximately 0.9), turned out to be not very foaming. The poor foaming correlated with its much lower concentration of extracellular proteins, confirming earlier observation that cellulase did not cause active foaming compared to certain other proteins present in the broth, and the selective separation of cellulase by foam fractionation requires the affinity foaming developed in this work.

XH had a stronger foaming ability than CH, as indicated by the substantially larger foam volumes obtained with XH than with CH in Table 3. The two hydrolysates performed similar in enrichment of reducing sugars. Compared to CH, XH had slightly lower ER for both FPU and extracellular proteins. The FPU enrichment in the lactose-based broth supernatant is not very high, up to approximately 1.8, as compared to that in the hydrolysate-based broth supernatant, up to 3.5-4.5. However, it should be noted that there is less room for enrichment and purification in the lactose-based supernatant because it is much richer and purer in cellulase (with an E/P of approximately 5.6) than the hydrolysate-based supernatant (with an E/P of approximately 1.1) to begin with. Although the E/P value for pure cellulase is yet to be determined, the value reached about 18 and 9 in the foamate produced with 75% XH and CH, respectively, from the lactose-based broth supernatant. Both were much higher than the E/P value (up to approximately 6.5) obtained with 75% CH from the hydrolysate-based broth supernatant (FIG. 3).

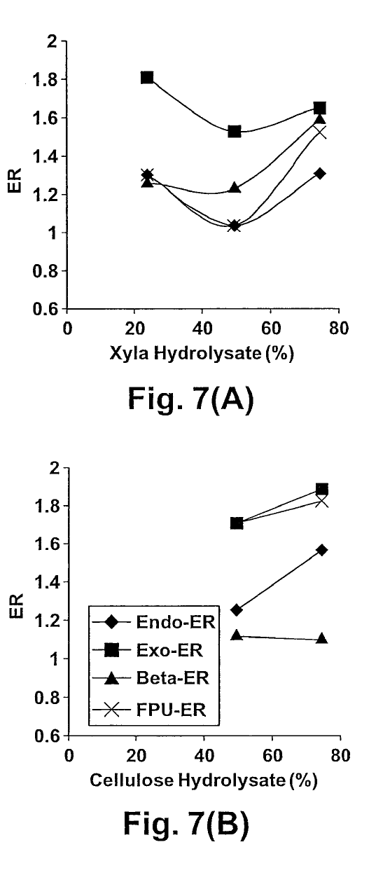

The effects of XH and CH, at different fractions, on foam fractionation of individual cellulase components are shown in FIG. 7. The CH-facilitated behaviors are similar in the hydrolysate-based broth supernatant (FIG. 3) and in the lactose-based broth supernatant (FIG. 7b): ER is highest for exoglucanases and lowest for β-glucosidase. XH also enriched exoglucanases the most from the lactose-based broth supernatant (FIG. 7a), but appeared to have the least enrichment for endoglucanases. Finally, XH is prepared having higher concentrations of oligomers than CH. Cellulase is nonetheless expected to have lower affinity to XH, than to CH, which can play a role in poorer enrichment of endoglucanases by XH.

### EXAMPLE 4

### Affinity Foam Fractionation with Addition of PMMA-co-MAA-Cellobiose

Another example of the present invention involves using one or more organic polymers to further enhance foam affinity. As shown in Scheme 1 below, cellobiose is reacted with hydrobromic acid thereby forming a brominated cellobiose derivative. The brominated derivative is then reacted with a mercapto compound that acts as a linker for linking cellobiose to an organic polymer. In this case the mercapto compound is 3-mercaptophenol. But it is expected that a wide variety of linkers can perform adequately, and would be obvious to one of ordinary skill in the art. Thus, all such linkers are also within the scope of the present invention.

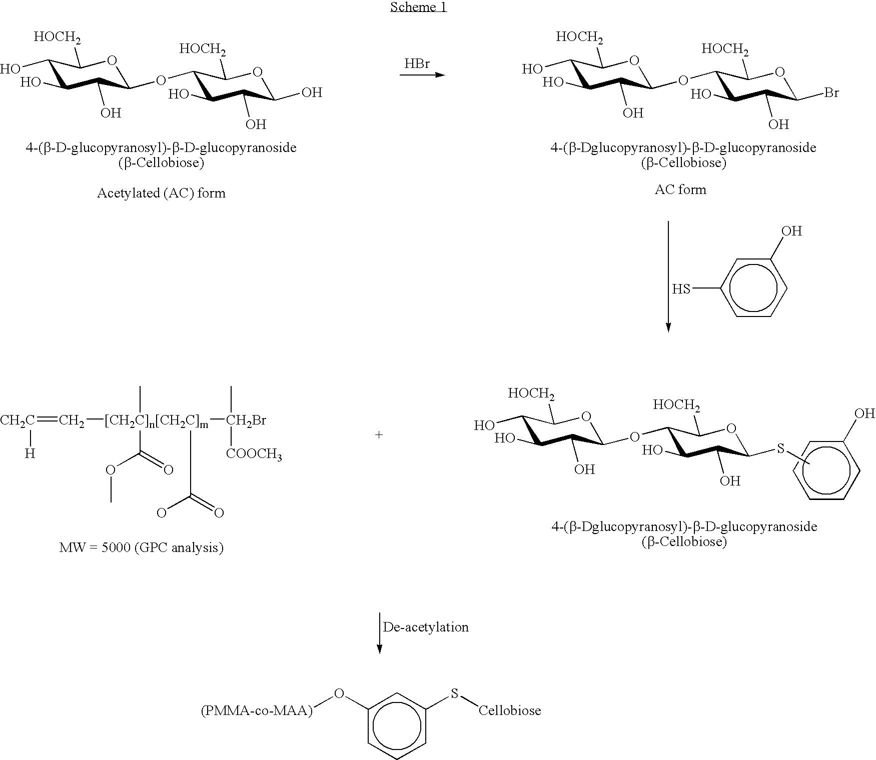

According to Scheme 1, the mercapto derivative of cellobiose then reacts with an organic polymer, such as polymethyl methacrylate (PMMA), polymethacrylic acid (PMAA), and/or any co-polymer thereof. The polymer derivatized cellobiose is thereby rendered better able to partition into a bubble surface, i.e. be separated by foam fractionation. Thus, cellulases that specifically bind to cellobiose are also more efficiently purified by foam fractionation. In some embodiments the average molecular weight of the PMMA and/or PMMA is about 5000 g/mol. It is expected that a wide variety of organic compounds would also perform adequately, and would be obvious to one of ordinary skill in the art. Thus, all such organic polymers are also within the scope of the present invention. Some examples of such organic polymers include, without limitation, polyolefins, polyethylene terephthalates, polyacrylamides, polystyrenes, polyphenols, polythiophenes, polynitriles, polyesters, polycarbonates, polypeptides, or any copolymer and/or combination thereof.

The effect of the polymer alone on cellulase foam fractionation efficacy is shown in Table II below. The first row is a control showing the efficacy of separating cellulase where the system has no added polymer and no cellobiose. The efficacy is expressed both in terms of FPU ER (1.69) and Extra-P ER (1.83). Additionally, the pH of the broth is shown, as well as the volume of the foam produced.

TABLE II

| | | | | Foam Volume |
|---|---|---|---|---|
| | FPU ER | Extra-P ER | pH | (mL) |
| Broth foamate | 1.69 | 1.83 | 5 | 60 |
| foamate w/P (0.128 g/L) | 2.56 | 3.1 | 4.95 | 120 |
| foamate w/P (0.064 g/L) | 3 | 3.2 | 4.96 | 130 |

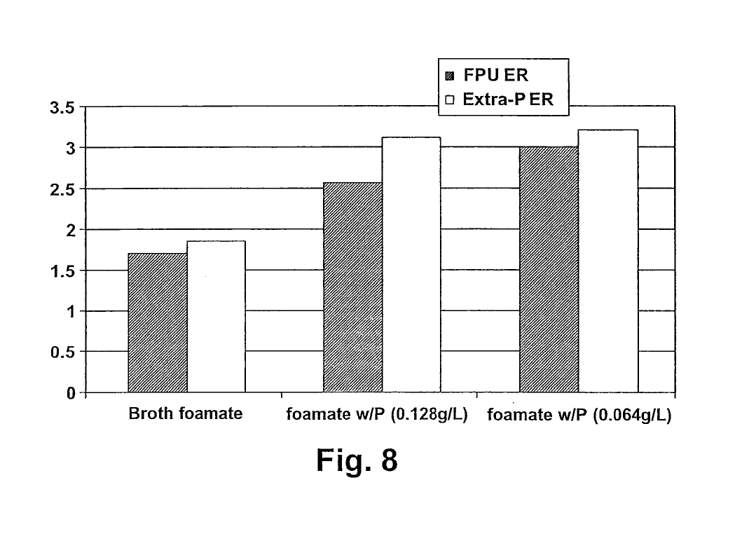

The second row shows the effect of adding PMMA-co-MAA polymer up to a concentration of about 0.128 g/L. This results in significantly higher enrichment ratios (i.e. 2.56, and 3.1). The third row shows the effect of adding about half the amount of organic polymer compared to the second row, i.e. about 0.064 g/L. The result is a further enhancement of the enrichment ratios. Since these embodiments lack cellobiose, the cellulase is being non-specifically foamed out of the broth. These data can be seen in graph form in FIG. 8.

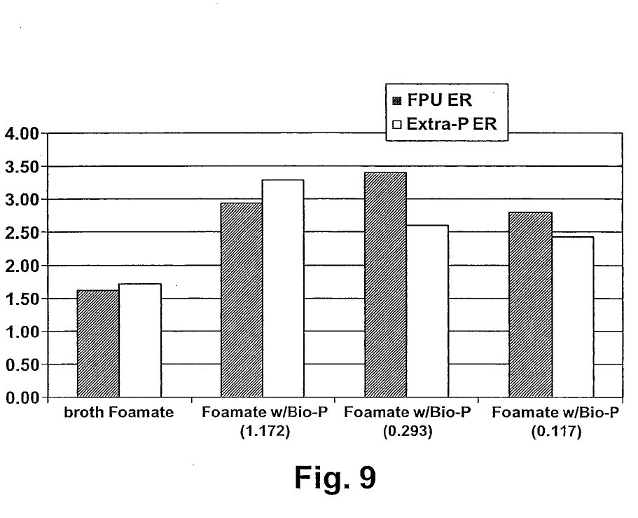

In other embodiments, a polymer such as PMMA-co-MAA is bonded to cellobiose, thereby more specifically foaming out cellulase from the broth. Data related to such embodiments is shown in Table III. In row one of Table III a broth control is foamed without PMMA-co-MAA-cellobiose. In that case, the enrichment ratios are 1.61 and 1.69, which is comparable to the control of Table II (as expected). In rows 2, 3, and 4 of Table III PMMA-co-MAA-cellobiose is added up to concentrations of about 1.172 g/L, 0.293 g/L, and 0.117 g/L respectively. In this embodiment, the peak enrichment ratios exceed those of the embodiments lacking cellobiose. These data can also be seen in graphical form in FIG. 9.

TABLE III

| | | | | Foam Volume |
|---|---|---|---|---|
| | FPU ER | Extra-P ER | pH | (mL) |
| broth Foamate | 1.61 | 1.69 | 5.00 | 60.00 |
| Foamate w/Bio-P (1.172) | 2.94 | 3.29 | 4.80 | 170.00 |
| Foamate w/Bio-P (0.293) | 3.39 | 2.61 | 3.40 | 190.00 |
| Foamate w/Bio-P (0.117) | 2.80 | 2.42 | 4.99 | 170.00 |

### EXAMPLE 5

### Affinity Foam Fractionation with Addition of Rhamnolipids

In other embodiments the affinity foaming agent is one or more rhamnolipids having a structure similar to that which is shown below. Such rhamnolipids are biosurfactants that can be obtained from Pseudomonads. In some embodiments it can be advantageous to grow the Pseudomonads on a hydrophobic substrate such as hydrocarbons. They generally have one or two rhamnose moieties linked to a hydroxyl group of a hydroxydecanoic acid. Usually, the acid is also esterified with another fatty acid, which may or may not be another decanoic acid.

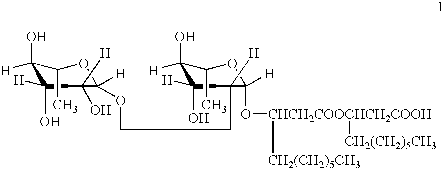

This particular rhamnolipid can be obtained from Pseudomonas aeruginosa. The di-rhamnose portion of the structure is a high-affinity substrate analog of cellulases, particularly β-glucosidases. In one embodiment, this rhamnolipid can be used to foam fractionate one or more β-glucosidases. Furthermore, this rhamnolipid is capable of purifying β-glucosidases more than 22 fold, as shown in Table IV below.

TABLE IV

| | | Activity | FPU-ER |
|---|---|---|---|
| Broth-only control | Broth Foamate | 0.0195 | 1.126 |
| | Broth Residue | 0.0173 | |
| 0.4 g/L sophorolipid | S.L. + broth Foamate | 0.0345 | 0.949 |
| (2) | S.L. + broth Residue | 0.0364 | |
| 0.4 g/L rhamnolipid | R.L + pure cellulase Foamate | 0.0232 | 22.174 |
| (1) cellulase 0.1 g/L | | | |
| | R.L + pure cellulase Residue | 0.0010 | |
| 0.4 g/L | De. S.L. + broth Foamate | 0.0294 | 1.718 |
| de-acetylated (3) | | | |
| Sophorolipid | | | |
| | De. S.L. + broth Residue | 0.0171 | |

### EXAMPLE 6

### Affinity Foam Fractionation with Addition of Sophorolipids

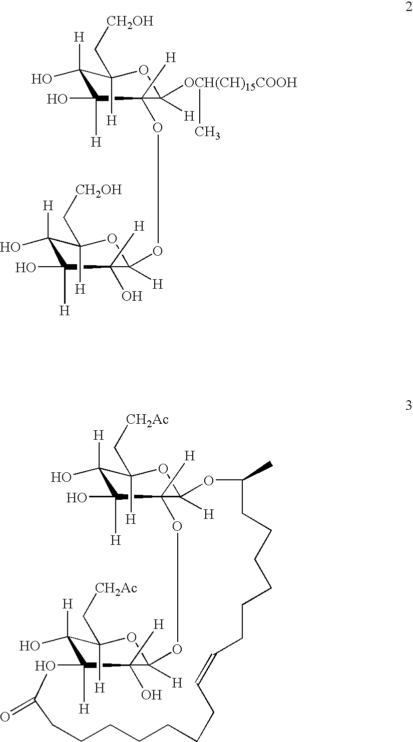

In other embodiments the rhamnolipid is replaced with one or more sophorolipids. Examples of sophorolipids within the scope of the present invention include, without limitation, structures 2 and 3. Similar to the rhamnolipid embodiments, the disaccharide moiety functions as a high-affinity substrate or substrate analog for β-glucosidase and other cellulase enzymes, and the hydrocarbon moiety enhances the molecule's tendency to partition onto a bubble surface, e.g. a foam. The results of structure 2 are shown in row 2, and indicate an FPU-ER of 0.949 at 0.4 g/L. The results of structure 3 are shown in row 4, and indicate an FPU-ER of 1.718 at 0.4 g/L.

Structures 2 and 3 can be obtained from yeast of genera Candida and/or Torulopsis. One species capable of producing these compounds is Candida bombicola. This particular species is capable of producing the foregoing compounds in large quantities, e.g. about 300 g per liter of culture. As known to one of skill in the art, the yeast can be caused to produce predominantly structure 2 or predominantly structure 3 by appropriately adjusting culture conditions.

Examples of other hydrocarbon moieties within the scope of the present invention include, without limitation, alkanes having 6 to 20 carbons, mono-olefins having 6 to 20 carbons, saturated fatty acids having 6 to 20 carbons, mono-unsaturated fatty acids having 6 to 20 carbons, poly-unsaturated fatty acids having 6 to 20 carbons, and/or any combination thereof. It is expected that a wide variety of other hydrocarbon moieties would also perform acceptably, and that such moieties would readily occur to one of ordinary skill in the art. Thus, all such modifications are also within the scope of the present invention.

In addition to di-rhamnose and di-sophorose, other disaccharides within the scope of the present invention include those which contain hexoses and/or ketohexoses such as allose, altrose, glucose, mannose, gulose, idose, galactose, talose, fructose, psicose, sorbose, tagatoses, or any combination thereof. Furthermore, it is expected that other disaccharides would also perform acceptably, and would readily occur to one of ordinary skill in the art. Accordingly all such modifications are within the scope of the present invention.

The process of the present invention is, among other things, environmentally friendly, economically effective, and ready for scale-up. It is applicable to the collection and purification of many materials, and in one embodiment is suitable for biological materials.

Although the invention has been described in detail with particular reference to certain embodiments detailed herein, other embodiments can achieve the same results. Variations and modifications of the present invention will be obvious to those skilled in the art and the present invention is intended to cover in the appended claims all such modifications and equivalents.

What is claimed is:

1. A process for separating, concentrating and/or purifying a material from a solution or mixture using a foam, comprising the steps of:
modifying a composition to be separated, concentrated and/or purified to enhance the material's affinity for a foam;
forming a foam from a solution containing the modified composition; and
separating, concentrating and/or purifying the composition from the foam.

2. The process of claim 1, wherein the composition is one or more of an enzyme, a substrate of an enzyme, a nucleic acid, a protein having an affinity for one or more nucleic acids, an antibody, an antigen, a cell receptor protein, a ligand of a cell receptor protein, a carbohydrate, a lectin, a compound bonded to avidin, a compound bonded to streptavidin, or any combination thereof.

3. The process of claim 1, wherein enzyme substrate comprises one or more of cellulose, xylan hydrolysate, cellulose hydrolysate, carboxymethylcellulose, allose, altrose, glucose, mannose, gulose, idose, galactose, talose, fructose, psicose, sorbose, tagatoses, or any combination thereof.

4. The process of claim 1, wherein the composition is derivatized with an affinity-foaming agent.

5. The process of claim 4, wherein the composition is derivatized with an affinity-foaming agent comprising one or more of an enzyme, a substrate of an enzyme, a nucleic acid, a protein having an affinity for one or more nucleic acids, an antibody, an antigen, a cell receptor protein, a ligand of a cell receptor protein, a carbohydrate, a lectin, a compound bonded to avidin, a compound bonded to streptavidin, or any combination thereof.

6. The process of claim 2, wherein the composition comprises one or more of cellulase, endoglucanases, exoglucanases, β-glucosidases, or any combination thereof.

7. The process of claim 6, wherein the composition comprises one or more of a β-1,4-glucan glycoanohydrolyase, a β-1,4-glucan cellobiohydrolyase, a β-glucosidase, or any combination thereof.

8. The process of claim 6, wherein the composition is an enzyme obtained from fermentation of one or more of Trichoderma reesei, Clostridium thermocellum, Ruminococcus albus, Streptomyces, Thermoactinomyces, Thermomonospora curvata, Acremonium cellulolyticus, Aspergillus acculeatus, Aspergillus fumigatus, Aspergillus niger, Fusarium solani, Irpex lacteus, Penicillium funmiculosum, Phanerochaete chrysosporium, Schizophyllum commune, Sclerotium rolfsii, Sporotrichum cellulophilum, Talaromyces emersonii, Thielavia terrestris, Trichoderma koningii, Trichoderma reesei, Trichoderma viride.

9. A process for foam fractionating chemical compounds comprising:
providing a vessel for containing a liquid comprising one or more chemical compounds to be fractionated, wherein the vessel includes a means for foaming the liquid contained therein;
providing the liquid disposed in the vessel and containing one or more chemical compounds to be fractionated, wherein the one or more chemical compounds are modified with an affinity-foaming agent so that they tend to preferentially segregate onto a foam rather than the liquid;
activating the means for foaming, thereby forming the foam from the liquid; and
collecting the foam.

10. The process of claim 9, wherein the liquid further comprises one or more affinity-foaming agents selected from one or more of rhamnolipids, sophorolipids, PMMA-co-PMAA-cellobiose.

11. The process of claim 9, further comprising the step of adding one or more affinity-foaming agents for increasing the tendency of the one or more chemical compounds to segregate in the foam rather than the liquid.

12. The process of claim 9, wherein the collected foam comprises the one or more compounds at a concentration about 2 to 100 times more concentrated than before fractionation.

13. The process of claim 9, wherein the collected foam comprises the one or more compounds at a concentration about 40 to 100 times more concentrated than before fractionation.

14. The process of claim 9, wherein the collected foam comprises the one or more compounds at a concentration about 2 to 5 times more concentrated than before fractionation.

15. The process of claim 9, wherein the one or more affinity-foaming agents comprise one or more of cellulose, xylan hydrolysate, cellulose hydrolysate, carboxymethylcellulose, allose, altrose, glucose, mannose, gulose, idose, galactose, talose, fructose, psicose, sorbose, tagatoses, or any combination thereof.

16. The process of claim 9, wherein the one or more compounds comprise one or more of an enzyme, a substrate of an enzyme, a nucleic acid, a protein having an affinity for one or more nucleic acids, an antibody, an antigen, a cell receptor protein, a ligand of a cell receptor protein, a carbohydrate, a lectin, a compound bonded to avidin, a compound bonded to streptavidin, or any combination thereof.

17. The process of claim 16, wherein the one or more compounds comprise one or more of cellulase, endoglucanases, exoglucanases, β-glucosidases, or any combination thereof.

18. The process of claim 16, wherein the one or more compounds comprise one or more of β-1,4-glucan glycoanohydrolyase, a β-1,4-glucan cellobiohydrolyase, a β-glucosidase, or any combination thereof.

19. A product purified by the process of claim 9.
